(19) United States
(12) Patent Application Publication
(10) Pub. No.: US 2014/0052897 A1
(43) Pub. Date: Feb. 20, 2014

(54) DYNAMIC FORMATION OF GARBAGE COLLECTION UNITS IN A MEMORY

(71) Applicants: Ryan James Goss, Prior Lake, MN (US); Mark Allen Gaertner, Vadnais Heights, MN (US); David Scott Seekins, Shakopee, MN (US)

(72) Inventors: Ryan James Goss, Prior Lake, MN (US); Mark Allen Gaertner, Vadnais Heights, MN (US); David Scott Seekins, Shakopee, MN (US)

(73) Assignee: SEAGATE TECHNOLOGY LLC, Cupertino, CA (US)

(21) Appl. No.: 13/588,716

(22) Filed: Aug. 17, 2012

(51) Int. Cl. G06F 12/02; G06F 12/00

(52) U.S. Cl. 711/103; 711/156; 711/E12.001; 711/E12.008

(57) ABSTRACT

Method and apparatus for managing data in a memory, such as but not limited to a flash memory. In accordance with some embodiments, a memory is provided with a plurality of addressable data storage blocks which are arranged into a first set of garbage collection units (GCUs). The blocks are rearranged into a different, second set of GCUs responsive to parametric performance of the blocks.

### SUMMARY

Various embodiments of the present disclosure are generally directed to a method and apparatus for managing data in a memory, such as but not limited to a flash memory.

In accordance with some embodiments, a memory is provided with a plurality of addressable data storage blocks which are arranged into a first set of garbage collection units (GCUs). The blocks are rearranged into a different, second set of GCUs responsive to parametric performance of the blocks.

These and other features which may characterize various embodiments can be understood in view of the following detailed discussion and the accompanying drawings.

### BRIEF DESCRIPTION OF THE DRAWINGS

FIG. 1 provides a functional block representation of an exemplary data storage device arranged to communicate with a host device in accordance with some embodiments.

FIG. 2 shows a hierarchy of addressable memory levels in the memory of FIG. 1.

FIG. 3 shows a flash memory cell construction that can be used in the device of FIG. 1.

FIG. 4 is a schematic depiction of a portion of a flash memory array using the cells of FIG. 3.

FIG. 5 illustrates an exemplary format for an erasure block of the memory array.

FIG. 6 shows the arrangement of multiple erasure blocks from the memory array into garbage collection units (GCUs).

FIG. 7 shows different distributions of charge that may be stored in populations of memory cells in the array of FIG. 6.

FIG. 8 displays an exemplary read operation sequence to read a programmed value of one of the memory cells of the memory array.

FIG. 9 illustrates different specified read-threshold values that may be issued during the read operation sequence of FIG. 8.

FIG. 10 is a functional block representation of a GCU formation and allocation module that operates in accordance with some embodiments.

FIG. 11 shows the reconfiguring of a selected GCU by the module of FIG. 10.

FIG. 12 is a flow chart for a DATA MANAGEMENT routine generally illustrative of steps carried out in accordance with some embodiments.

FIG. 13 illustrates different sets of GCUs formed in accordance with some embodiments.

FIG. 14 provides an exemplary format for metadata used with the sets of GCUs in FIG. 13.

### DETAILED DESCRIPTION

The present disclosure generally relates to the management of data in a memory, such as but not limited to a flash memory of a data storage device.

A wide variety of data storage memories are known in the art. Some memories take the form of solid-state memory cells arrayed on a semiconductor substrate. Solid-state memory cells may store data in the form of accumulated electrical charge, selectively oriented magnetic domains, phase change material states, ion migration, and so on. Exemplary solid-state memory cell constructions include, but are not limited to, static random access memory (SRAM), dynamic random access memory (DRAM), non-volatile random access memory (NVRAM), electrically erasable programmable read only memory (EEPROM), flash memory, spin-torque transfer random access memory (STRAM), magnetic random access memory (MRAM) and resistive random access memory (RRAM).

These and other types of memory cells may be programmed to a selected state during a write operation, and the programmed state may be subsequently read during a read operation. A read operation may include the application of a read voltage threshold to the associated memory cell in order to sense the programmed state. An erasure operation can be applied to return a set of memory cells to an initial default programmed state.

Blocks of memory cells may be grouped together into garbage collection units (GCUs), which are allocated and erased as a unit. In some cases, GCUs may be formed by grouping together one erasure block from each plane and die in a memory device. This can enhance operational efficiency since generally only one operation (e.g., an erasure) can be carried out on a per plane and per die basis.

It has been found that erasure blocks in the same GCU may exhibit different parametric performance characteristics. Such variations can adversely impact device performance, since the time or resources necessary to perform a given action, such as a read operation upon a selected GCU, may be limited by the worst performing block in that GCU (e.g., the slowest or otherwise hardest to read block, etc).

Accordingly, various embodiments of the present disclosure are generally directed to improving data management in a memory, such as but not limited to a flash memory array. As explained below, erasure blocks of memory cells in a data storage device are combined to form a first grouping of GCUs. Data write, read and/or erasure operations are carried out to the various GCUs over an extended interval during normal operation of the device.

At the conclusion of the operational interval, the parametric performance of the GCUs is evaluated on a block-by-block basis. Based on the results of the evaluation, the blocks are regrouped into different combinations to form a second grouping of GCUs. The reformatted GCUs have blocks with common parametric performance measurements. In this way, access operations upon the reformatted GCUs encounter reduced variations in performance from block to block.

In further embodiments, the reformatted GCUs are used for different tasks suited to their respective performance levels. Blocks exhibiting relatively faster response performance can be grouped into GCUs dedicated to servicing more frequently accessed data. Blocks exhibiting lower error rates or other degradation effects (e.g., read disturbances, etc.) can be used to store higher priority data, and so on.

In still further embodiments, a currently allocated GCU can be augmented on-the-fly by adding additional blocks to the GCU having similar performance characteristics as the existing blocks in the GCU. This can extend the useful life of the GCU by increasing the total data storage capacity of the GCU and delaying the need to perform a garbage collection operation to erase and return the GCU to service.

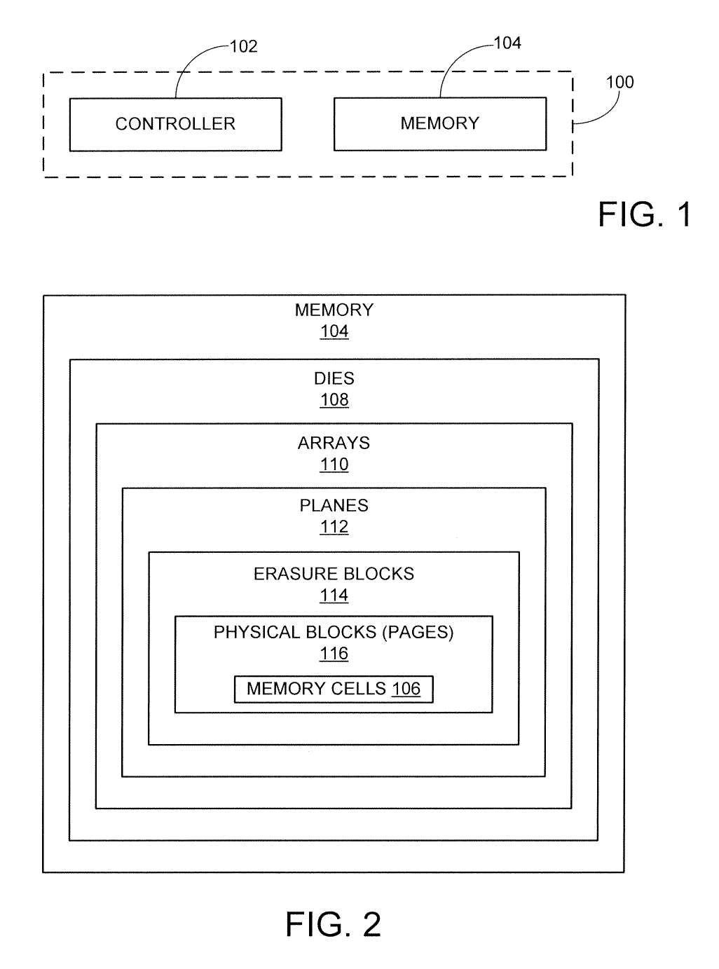

These and other features of various embodiments can be understood beginning with a review of FIG. 1, which provides a simplified block diagram of a data storage device 100. The device 100 includes a controller 102 and a memory module 104.

The controller 102 provides top level control for the device, and may be realized as a hardware based or programmable processor. The memory module 104 provides a main data store for the device 100, and may be a solid-state memory array, disc based memory, etc. While not limiting, for purposes of providing a concrete example the device 100 will be contemplated as a non-volatile data storage device that utilizes flash memory in the memory 104 to provide a main memory for a host device (not shown).

FIG. 2 illustrates a hierarchical structure for the memory 104 in FIG. 1. The memory 104 includes a number of addressable elements from a highest order (the memory 104 itself) to lowest order (individual flash memory cells 106). Other structures and arrangements can be used.

The memory 104 takes the form of one or more dies 108. Each die may be realized as an encapsulated integrated circuit (IC) having at least one physical, self-contained semiconductor wafer. The dies 108 may be affixed to a printed circuit board (PCB) to provide the requisite interconnections. Each die incorporates a number of arrays 110, which may be realized as a physical layout of the cells 106 arranged into rows and columns, along with the associated driver, decoder and sense circuitry to carry out access operations (e.g., read/write/erase) upon the arrayed cells.

The arrays 110 are divided into planes 112 which are configured such that a given access operation can be carried out concurrently to the cells in each plane. For example, an array 110 with eight planes 112 can support eight concurrent read operations, one to each plane.

The cells 106 in each plane 112 are arranged into individual erasure blocks 114, which represent the smallest number of memory cells that can be erased at a given time. Each erasure block 114 may in turn be formed from a number of pages (rows) 116 of memory cells. Generally, an entire page worth of data is written or read at a time.

FIG. 3 illustrates an exemplary flash memory cell 106 from FIG. 2. Localized doped regions 118 are formed in a semiconductor substrate 120. A gate structure 122 spans each pair of adjacent doped regions 118 and includes a lower insulative barrier layer 124, a floating gate (FG) 126, an upper insulative barrier layer 128 and a control gate (CG) 130. The flash cell 106 thus generally takes a form similar to a nMOSFET (n-channel metal oxide semiconductor field effect transistor) with the doped regions 118 corresponding to source and drain terminals and the control gate 130 providing a gate terminal.

Data are stored to the cell 106 in relation to the amount of accumulated charge on the floating gate 126. A write operation biases the respective doped regions 118 and the control gate 130 to migrate charge from a channel region (CH) across the lower barrier 124 to the floating gate 126. The presence of the accumulated charge on the floating gate tends to place the channel in a non-conductive state from source to drain. Data are stored in relation to the amount of accumulated charge.

A greater amount of accumulated charge will generally require a larger control gate voltage to render the cell conductive from source to drain. Hence, a read operation applies a sequence of voltages to the control gate 130 to identify a voltage magnitude required to place the channel in a conductive state, and the programmed state is determined in relation to the read voltage magnitude. An erasure operation reverses the polarities of the source and drain regions 118 and the control gate 130 to migrate the accumulated charge from the floating gate 126 back to the channel.

The cell 106 can be configured as a single-level cell (SLC) or a multi-level cell (MLC). An SLC stores a single bit; a normal convention is to assign the logical bit value of 1 to an erased cell (substantially no accumulated charge) and a logical bit value of 0 to a programmed cell (presence of accumulated charge). An MLC stores multiple bits, such as two bits. Generally, n bits can be stored using 2ⁿ storage states.

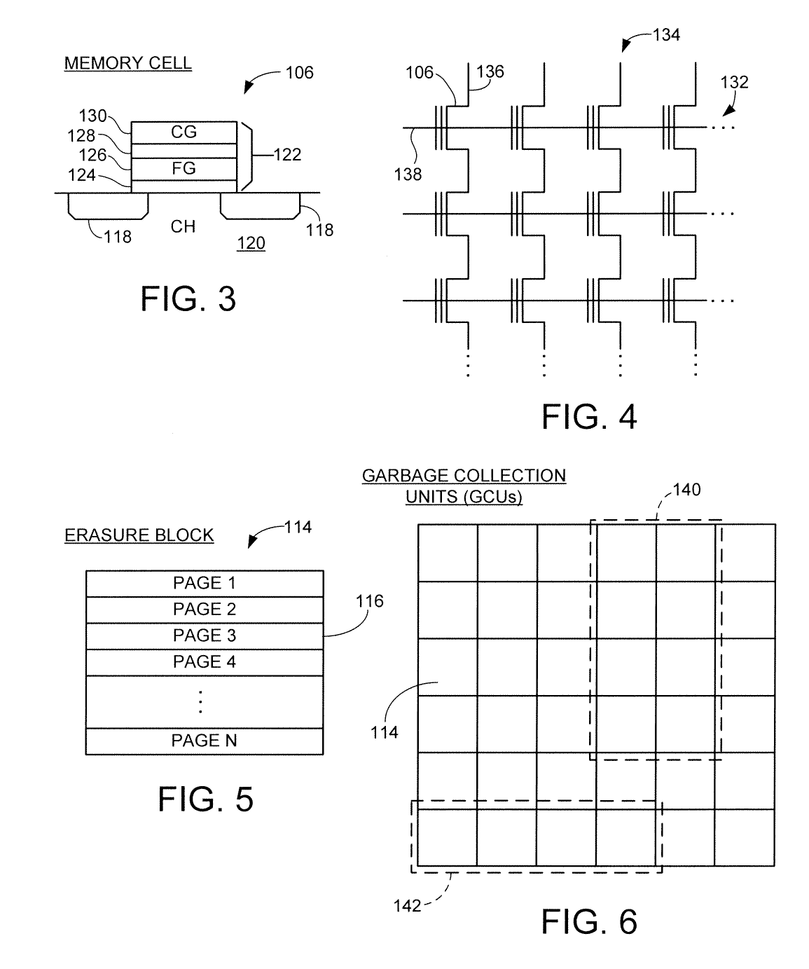

FIG. 4 shows memory cells such as 106 in FIG. 3 arranged into rows 132 and columns 134. Each column 134 of adjacent cells can be coupled via one or more bit lines (BL) 136. The control gates 130 of the cells 106 along each row 132 can be interconnected via individual word lines (WL) 138.

An exemplary format for a selected erasure block 114 is depicted in FIG. 5. The block 114 includes N pages 116, with each page corresponding to a row 132 in FIG. 4. The erasure blocks 114 are combined into multi-block garbage collection units (GCUs) as represented in FIGS. 6 at 140 and 142. It will be noted that the various erasure blocks 114 shown in FIG. 6 may not be necessarily physically adjacent one another.

The GCU 140 is formed of eight (8) erasure blocks 114, and a second GCU 142 is formed of four (4) erasure blocks 114. The GCUs in a given memory may all be the same size, or may have different sizes. All of the erasure blocks 114 may be initially grouped into GCUs, or the GCUs may be formed and allocated (placed into service to store data) as needed during the operational life of the device.

A garbage collection operation generally entails identifying currently valid data within the associated GCU, migrating the valid data to another location (e.g., a different GCU), performing an erasure on each of the erasure blocks in the GCU, and then placing the erased GCU into a reallocation pool pending subsequent allocation.

In accordance with the present disclosure, GCUs such as 140 and 142 are dynamically formatted over the operational life of the device 100 by grouping together erasure blocks 114 exhibiting similar parametric performance. The types of parametric performance metrics utilized in GCU formatting operations can take a variety of forms. One set of performance metrics relates to charge distributions of the various memory cells in the erasure blocks.

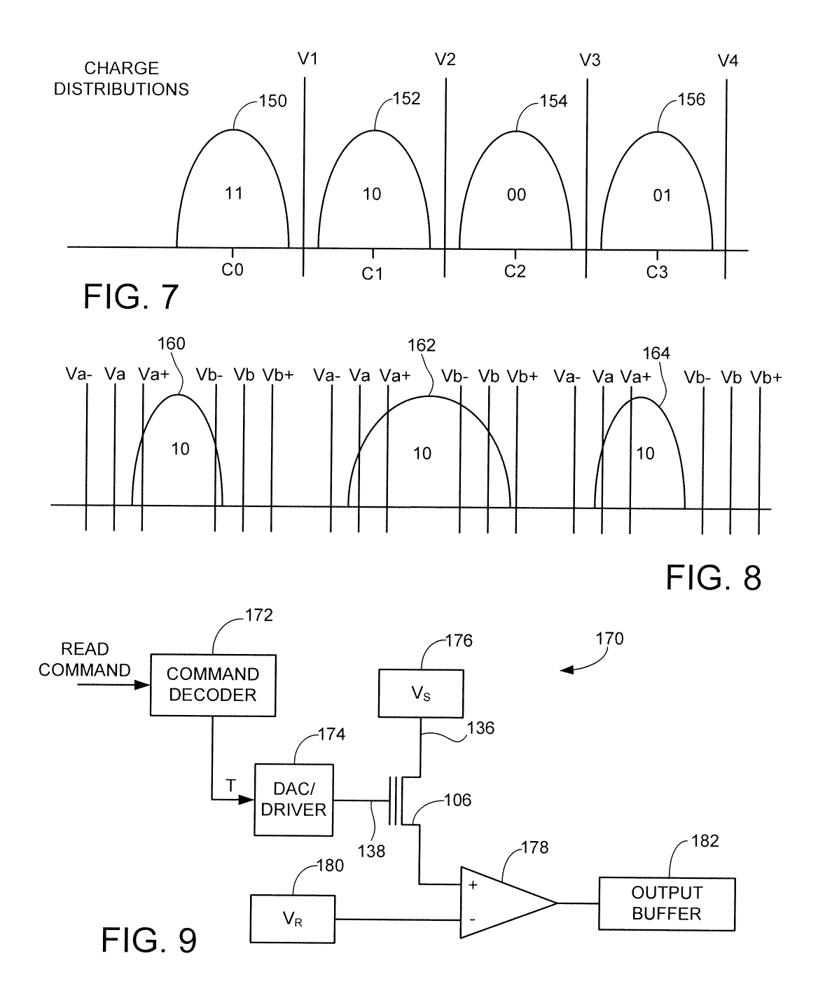

FIG. 7 represents a population of memory cells from the memory 104 with individual charge distributions 150, 152, 154 and 156. These distributions are centered about nominal charge distributions C0-C3, and respectively represent MLC programmed states of 11, 10, 00 and 01. The respective programmed states can be nominally sensed by applying a sequence of read voltages V1-V4 to the control gates 130 (FIG. 3) of the cells, and determining whether a particular read voltage is sufficient to place the associated cell into a conductive state. For example, read voltage V1 is sufficient to nominally place all of the cells in the distribution 150 (programmed state 11) in a conductive state, while insufficient to place the cells in the remaining distributions 152, 154 and 156 in a conductive state.

At this point it will be noted that the scheme in FIG. 7 advantageously facilitates the storage of two sets (pages) worth of data to each physical row 132 of cells. A first set of data can be written using SLC programming, so that the cells are in either distribution 150 (C0) or distribution 154 (C2). A second set of data can thereafter be written to the row 132 using MLC programming, so that at least some of the cells may fall within distribution 152 (C1) or distribution 156 (C3). The most significant bits (MSBs) represent the data bits for the first set of data, and the least significant bits (LSBs) represent the data bits for the second set of data.

The charge distribution ranges in FIG. 7 represent variations in the total amount of accumulated charge on the individual cells. Some of this variation may relate to the programming process whereby discrete quanta of charge are sequentially applied to the cells to raise the total amount of accumulated charge to the desired range.

Other variations in the charge distributions can arise due to operational factors; for example, a phenomenon referred to as read disturbance generally operates to modify the amount of total accumulated charge on a cell due to repeated read operations to the cell, or to adjacent cells. Read disturbance tends to induce drift in the charge distribution, either in terms of more accumulated charge (shift to the left in FIG. 7) or less accumulated charge (shift to the right).

The construction of the cells can also impart variation to a charge distribution since manufacturing variations can affect the extent to which charge is transferred across the lower barrier layer. Wear can also contribute to charge distribution variation. The greater the number of write/erasure cycles on a particular cell, generally the less capable the cell may become in terms of both accepting charge during a programming operation and returning charge to the channel during an erasure operation.

It follows that the location and range (e.g., width) of a respective charge distribution can be used to assess erasure block performance. FIG. 8 generally represents three alternative charge distributions 160, 162 and 164 for the cells in a selected erasure block programmed to a selected state (in this case, 10).

Distribution 160 is reasonably well behaved and generally has the same range and centered location as the distribution 152 in FIG. 7. Distribution 162 is also reasonably well centered but has a wider range than distributions 152 and 160. Distribution 164 has a similar range as distributions 152 and 160, but is shifted to the left, indicating that the cells have experienced read disturbance or other charge leakage effects.

The ranges and locations of the respective distributions 160, 162 and 164 can be evaluated by applying a succession of read voltages to the cells in the distribution. FIG. 8 shows nominal upper and lower read threshold voltages Va and Vb, in conjunction with banded read threshold voltages Va−, Va+, Vb− and Vb+. The banded voltages vary from the nominal read threshold values Va and Vb by some selected interval, such as +/−10%, etc.

FIG. 9 is a functional block diagram of read circuitry 170 of the device 100 adapted to apply the various threshold voltages in FIG. 8 to assess the distribution characteristics of a population of memory cells 106. A command decoder 172 decodes an input read command and outputs an appropriate read threshold value T to a digital-to-analog (DAC) driver circuit 174. The threshold value T is a multi-bit digital representation of a selected analog voltage value from FIG. 7 (e.g., voltage Va). The DAC/driver 174 applies the corresponding analog voltage to the gate structure of the selected cell 106 via the associated word line 138 (see FIG. 4).

A voltage source 176 applies a suitable voltage V_{S} to the associated bit line 136 coupled to the cell 106. A sense amplifier 178 determines whether the applied voltage is sufficient to place the cell 106 into a conductive state through a comparison with a reference voltage V_{R} from a reference voltage source 180. A resulting bit value is output to an output buffer 182 (e.g., a 0 or 1) responsive to the comparison.

The range and location of the charge threshold population for a set of cells can be determined by using the circuit of FIG. 9 to apply the various read threshold voltages in FIG. 8 to each cell in the population, and accumulating the results in memory for each of the evaluated memory cells.

For example, distribution 160 in FIG. 8 may be characterized by applying voltage Va, which will be insufficient to place any of the cells in the distribution into a conductive state. Voltage Va+, on the other hand, will be sufficient to place a small percentage of the cells in the distribution 160 into a conductive state (i.e., that area under the curve 160 to the left of line Va+). This sequence determines that the lower boundary of the distribution 160 falls between the voltages Va and Va+.

The voltages Vb and Vb− can be similarly applied to identify the location of the upper boundary of the distribution, since the voltage Vb will be sufficient to render all of the cells in the population in a conductive state and the voltage Vb− only able to render those cells conductive that fall to the right of voltage line Vb−. Additional read voltage thresholds can be applied as desired, including read voltages with greater resolution (e.g., +/−5%, etc.) as well as read voltages in the medial range between Va+ and Vb−.

This process can be repeated to provide an overall determination of the charge distribution characteristics of an erasure block, by evaluating each of the cells in the erasure block in turn. In some embodiments, a statistically significant sample of memory cells in the erasure block can be evaluated to make the determination. The evaluations can be limited to those cells having a specific programmed value (e.g., 10) or can be extended to cells having all of the programmed values (e.g., 11, 10, 00 and 11).

The evaluated erasure blocks can thereafter be sorted into different categories based on the types of exhibited parametric performance. The performance can include assessment of the location of the distribution such as “centered” versus “shifted low” or “shifted high,” and the width of the distribution such as as “narrow,” “normal” or “wide.” Other characterizations and classifications can be used.

Other parametric performance characterizations can be applied, such as but not limited to data aging, number of reads, number of write/erasure cycles, temperature (at the time of programming and/or ambient localized temperature during operation), observed error rates during data readback operations, whether the programming effort is relatively easy or hard, average elapsed read response time, average elapsed erasure response time, etc.

Parameters may be selected based on observed variation during the operation of a particular memory, so that a large number of available parameters may be initially identified, but only those parameters observed to exhibit sufficient variation are selected for use in the characterization process. Empirical analysis may be used to identify particular parameters that are correlated to different performance characteristics; for example, it may be determined that read error rates are a good indicator of cell reliability and data retention capabilities, and therefore read error rates may be selected as one of the parameters for use in evaluating the various blocks.

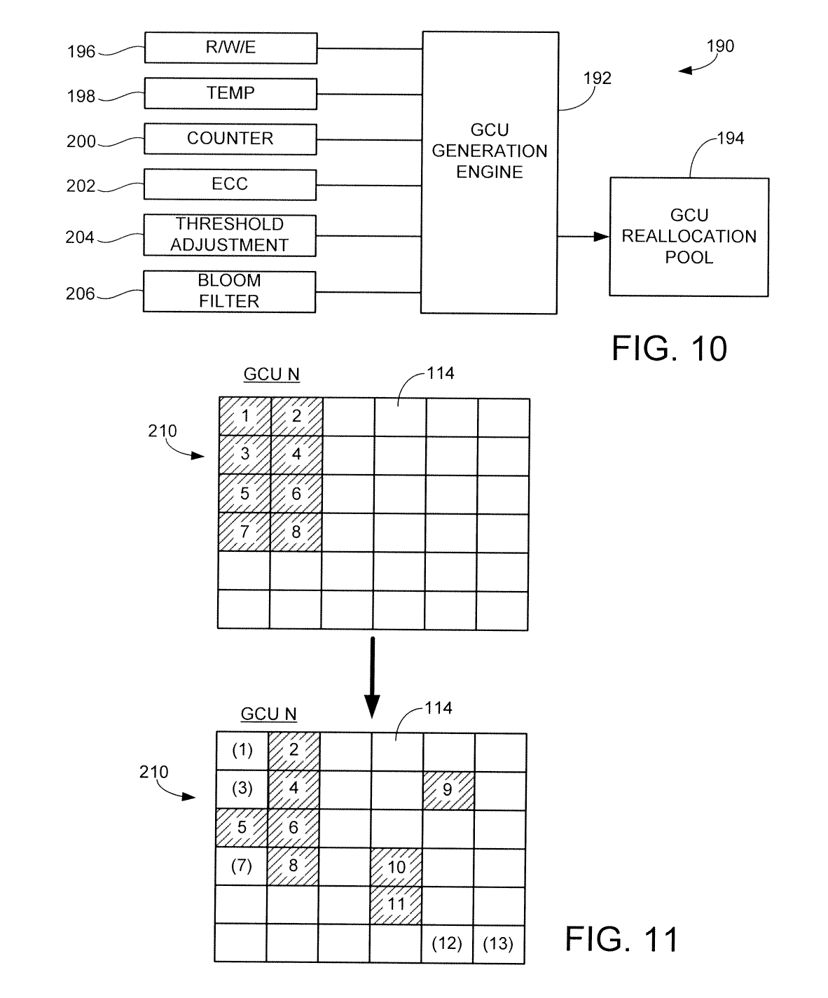

FIG. 10 depicts a GCU analysis circuit 190 of the device 100 in accordance with some embodiments. The circuit 190 includes a GCU generation engine 192 which operates to evaluate the parametric performance of the erasure blocks and reformat the GCUs accordingly. The engine 192 may be realized in hardware or in programming used by the device controller 102.

In some embodiments, the engine 192 establishes an initial grouping of GCUs in the memory 104, and places the initial GCUs into a reallocation pool 194 for use by the device.

The engine 192 thereafter initiates and accumulates parametric performance data over time, and then, as appropriate, reformats the GCUs into new groupings of erasure blocks with matched parametric performance. It will be appreciated that the reallocation pool 194 may take the form of a table or other data structure that identifies the physical addresses of the various erasure blocks and the associated GCUs, as well as other control data to enable the system to utilize the various GCUs as described herein.

The engine 192 receives inputs from a number of operational modules, such as a read/write/erasure (R/W/E) channel 196, a temperature sensor 198, a counter 200, an error correction code (ECC) circuit 202, a threshold adjustment module 204 and a bloom filter 206. The bloom filter can be used to achieve a running assessment of erasure block performance quality using a weighted analysis such as:

BQ(N)=K1(Mean)+K2(Range)+K3(Temp)+K4(Age)+K5(ECC) (1)

where “BQ(N)” is the erasure block quality measurement value for erasure block N, “Mean” is the average of a charge distribution population for cells in the erasure block, “Range” is the width of the distribution, “Temp” is a temperature value associated with the erasure block, “Age” is an aging value (e.g., number of write/erasure cycles, read operations, etc.), “ECC” is a measure of error rate performance for the erasure block during read operations, and K1-K5 are constants. Other measures can be used, including different combinations and weighting of factors, the use of higher order relations, etc. Empirical analyses can be carried out to select an appropriate quality measure model for a given application.

FIG. 11 graphically illustrates operation of the circuit 190 of FIG. 10 in accordance with some embodiments. A selected GCU 210, referred to as GCU N, is initially formed from a selected grouping of eight (8) erasure blocks 114. The erasure blocks 114 are identified in FIG. 8 as shaded blocks 1-8, and these may be physically proximate one another or physically discontinuous (e.g., disposed on different planes, arrays, dies, etc.).

After an extended operational time interval, the engine 192 measures the parametric performance of the erasure blocks, and uses the measurement results to reformat the GCU 210. As shown in FIG. 11, blocks 1, 3 and 7 are jettisoned from the GCU 210, and blocks 9-11 are added. The reformatted GCU 210 thus encompasses shaded blocks 2, 4-6 and 8-11. Although not shown in FIG. 11, it is contemplated that the jettisoned blocks 1, 3 and 7 are incorporated into a different GCU set, and that the new blocks 9-11 came from one or more other previously formed GCU sets.

The GCU reformatting operation can be carried out in a variety of ways. In some embodiments, all of the erasure blocks in the system are evaluated at the same time and new GCU groupings are established across the board. In other embodiments, each time a garbage collection operation takes place to erase an existing GCU and place it into the reallocation pool 194, a search is performed of the various erasure blocks for the existing GCUs in the pool to accumulate erasure blocks with matched performance. An advantage of this latter approach is that the GCU reformatting operation is carried out upon erasure blocks that do not currently store user data, so the impact on existing device operation is reduced.

In further embodiments, a list of unassigned erasure blocks 114 may be maintained in the reallocation pool 194 and a GCU is formed responsive to a host request, such as the presentation of data for storage to the memory 104. Depending on an indicated characteristic of the data (e.g., high priority data, data within a certain predetermined logical block address range, etc.), appropriate erasure blocks are selected for incorporation into the newly formed, allocated GCU. As before, the selected erasure blocks will have similar parametric performance characteristics suitable for the type of input data.

It is contemplated that the erasure blocks that are migrated to a new GCU will be from different planes, arrays and/or dies to improve operational efficiency by permitting the use of concurrent operations thereon. However, such is not necessarily required, since the operational improvements gained by using matched erasure blocks may offset the inability to carry out a maximum number of concurrent operations on those blocks. The scheme readily permits the use of arbitrarily defined sizes of GCUs, so that some GCUs may have a first number of erasure blocks (e.g., 8, etc.) and other GCUs may have a second number of erasure blocks, including non-standard numbers (e.g., 13, etc).

The engine 192 can further be configured to add one or more erasure blocks 114 to a currently allocated GCU. As noted above, the reformatted GCU 210 in FIG. 11 is shown to have a total of eight blocks (shaded blocks 2, 4-6, and 8-11). The GCU 210 may be modified on-the-fly to add additional blocks 12-13 found to have similar parametric performance to blocks 2, 4-6 and 8-11. Such modifications can advantageously extend the operational life of an existing GCU by increasing storage capacity and delaying the need to subject the GCU to a garbage collection operation. Suitable metadata can be generated and used to track the status of the various GCUs, erasure blocks, etc.

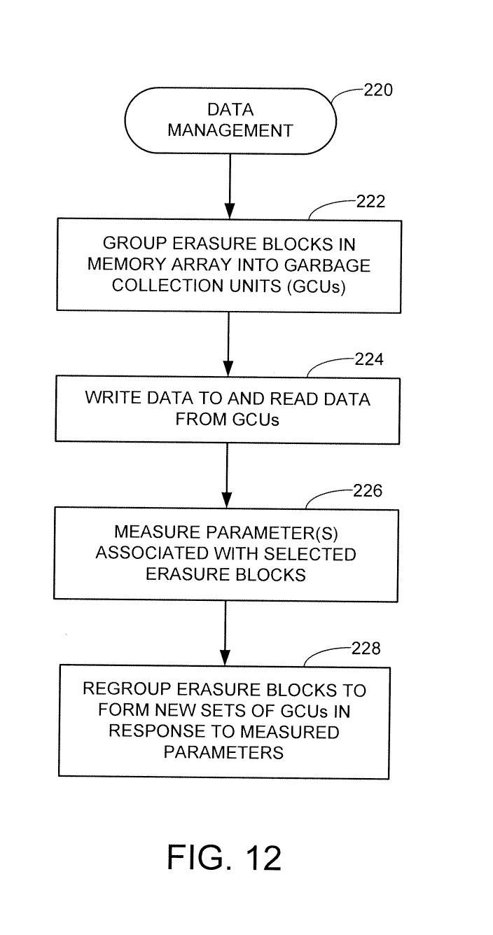

FIG. 12 provides a flow chart for a DATA MANAGEMENT routine 220 to illustrate steps that may be carried out in accordance with the foregoing discussion. At step 222, a memory, such as the flash memory 104 in FIG. 2, is formatted so that blocks 114 of memory cells 116 are grouped together to provide a first set (grouping) of GCUs. The initial GCU grouping can take place during device manufacturing or device formatting operations. A baseline grouping of the erasure blocks can be applied using a predetermined, standard format.

At step 224, normal operation commences during which the various GCUs are allocated for service, data are written thereto, data are read therefrom, and, depending on the application, one or more garbage collection operations are performed to erase and return at least some of the GCUs to service.

The time duration of step 224 can depend on a variety of factors, including total elapsed time, total I/O workload of the device, etc., provided that sufficient operational activity has taken place to allow evaluation of the parametric performance of a sufficient number of the blocks, as indicated at step 226. The parametric evaluation can take a number of different forms, including but not limited to those discussed above in FIGS. 8-10. Generally, any suitable parametric performance indicator can be used to evaluate and classify the respective blocks.

Once the evaluation has concluded, the erasure blocks are reformatted to form a new, second set (grouping) of GCUs in response to the analyzed parameters, as shown by step 228. It is contemplated, albeit not necessarily required, that evaluated GCUs will tend to lose at least one erasure block in favor of at least one new, replacement erasure block.

Depending on the stability of the system, it is possible that a relatively large amount of GCU reformatting will take place during the early stages of device operation, followed by a relatively longer period of time during which fewer GCU reformatting operations take place over the majority of the lifetime of the device.

Toward the end of the device operational life as erasure blocks begin to show wear, the device may increase the amount of GCU reformatting to identify and retain those erasure blocks still exhibiting good parametric performance. The device 100 can be configured to maintain performance statistics on the various erasure blocks and enact portions of the routine (e.g., steps 2)0, 212) at suitable times when significant changes in performance are detected.

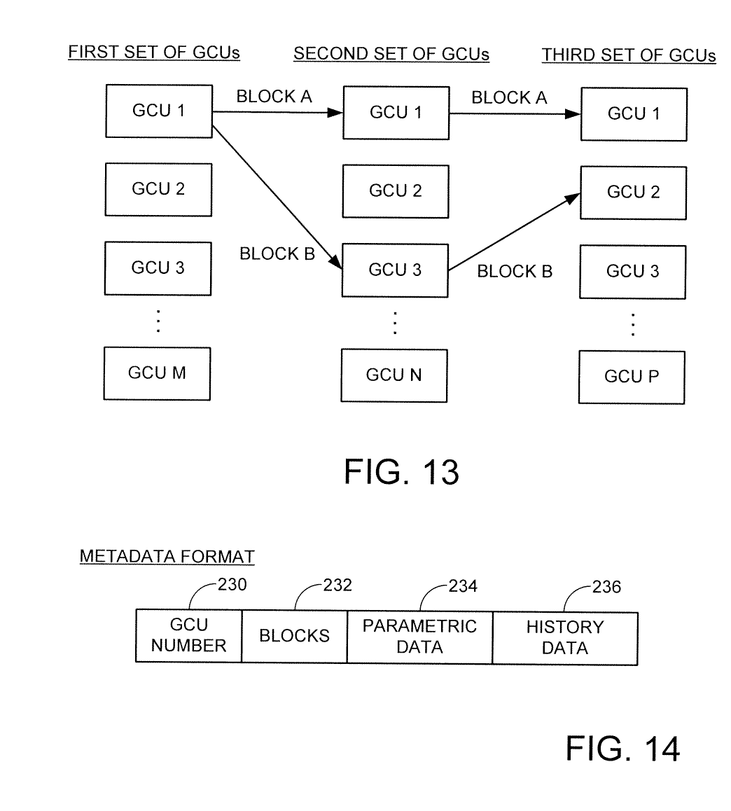

FIG. 13 illustrates first, second and third sets of GCUs formatted in accordance with the routine of FIG. 12. It is contemplated that the first set of GCUs is formed during an initial memory formatting operation, the second set of GCUs are reformatted after a first time interval of field operation of the device, and the third set of GCUs are reformatted after a subsequent second time interval of field operation of the device.

The first set of GCUs has a total number of M GCUs, the second set of GCUs has N GCUs, and the third set of GCUs has P GCUs. The respective total numbers M, N and P can be the same number, or can be different numbers. The respective sizes of the GCUs can also be the same (e.g., each GCU constitutes 8 erasure blocks, etc.), or different.

As shown by FIG. 13, some erasure blocks may tend to remain in the same GCU, such as block A which was initially included in GCU 1 and retained in GCU 1 after both reformatting operations. Other erasure blocks may be moved to different GCUs multiple times, such as Block B which began in GCU 1 but was migrated to GCU 3 and then to GCU 2. It will be appreciated that the various blocks can be migrated (or retained) in various combinations.

A tracking scheme can be used to track the various GCUs and associated erasure blocks. Generally, it may be beneficial to maintain the same GCU number for a given GCU even if, over time, some or even all of the erasure blocks are ultimately replaced. To this end, FIG. 14 provides a metadata format useful in accordance with some embodiments. The format includes a GCU number field 230, a blocks field 232, a parametric data field 234 and a history data field 236. Other formats can be used. The metadata may be stored in the GCUs or in other suitable memory locations accessible by the various system components (e.g., the controller 102, the engine 192, etc.).

The GCU number field 230 provides an assigned GCU number for the associated GCU, such as GCUs 1-M in FIG. 13. If the second set of GCUs increases the total number of GCUs in the system (e.g., N>M), then the newly formed GCUs can have incremented GCU numbers (e.g., N+1, N+2 . . . M−1, M). If the second set of GCUs decreases the total number of GCUs in the system (e.g., N<M), then some of the GCU numbers may be retired.

The blocks field 232 can be used to identify the erasure blocks in the associated GCU. The format can vary depending on the requirements of a given application. In some embodiments, the block field data may provide a multi-bit address representation to denote die, plane, array, block, etc. In other embodiments, the blocks may be assigned logical addresses (e.g., blocks 1-R) and a conversion table can be used to determine the physical addresses of the assigned blocks.

The parametric data field 234 can store the parameters around which the GCU is formed (e.g., good error rate performance, etc.). Additionally or alternatively, the actual measured parameter data can be stored in the field 234. The history data field 236 can store a history of the blocks in the GCU, including which blocks have been added (and when), as well as which blocks (if any) have been jettisoned from the initial grouping. In this way, the entire history of a given block (and a given GCU) can be reconstructed for data analysis purposes.

It will now be appreciated that the various embodiments disclosed herein can provide benefits over existing GCU allocation methodologies. A dynamic GCU formation mechanism as disclosed herein can identify and group erasure blocks, or other blocks of memory, to match observed parametric performance. While a flash memory array has been provided as an exemplary environment, such is merely for illustration purposes and is not limiting. The techniques disclosed herein are suitable for use in any number of different types of memories, including volatile and non-volatile memories.

It is to be understood that even though numerous characteristics and advantages of various embodiments of the present disclosure have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A method comprising
grouping a plurality of addressable data storage blocks of memory into a first set of garbage collection units (GCUs); and
rearranging the plurality of blocks into a different, second set of GCUs responsive to parametric performance of the blocks.

2. The method of claim 1, in which each block is an erasure block of memory cells adapted for concurrent erasure in a flash memory.

3. The method of claim 1, in which the first set of GCUs is formed during manufacture of the memory and the second set of GCUs is formed after a period of field operation of the memory in which data are transferred between the memory and a host device.

4. The method of claim 1, in which the first set of GCUs comprises a first GCU having a first total number of blocks, the second set of GCUs comprises a second GCU having a second total number of blocks, and one of the blocks in the first GCU is migrated to the second GCU.

5. The method of claim 1, in which the first and second sets of GCUs both have the same total number of GCUs.

6. The method of claim 1, in which the first set of GCUs has a first total number of GCUs and the second set of GCUs has a different, second total number of GCUs.

7. The method of claim 1, in which the parametric performance of the blocks comprises a distribution of charge stored by memory cells of the blocks.

8. The method of claim 1, in which the parametric performance of the blocks comprises an observed read error rate for data read from the blocks.

9. The method of claim 1, in which each of the second set of GCUs are placed into a reallocation pool, respectively allocated for use in storing data, and respectively subjected to a garbage collection operation.

10. The method of claim 1, in which each GCU in the second set of GCUs is formed by selecting blocks exhibiting a common parametric characteristic.

11. The method of claim 10, in which the common parametric characteristic comprises at least a selected one of error rate performance, data transfer speed, charge distribution, data aging, wear or write/erase cycles.

12. The method of claim 1, further comprising:
allocating a first GCU from the first set of GCUs for the storage of host data; and
performing a garbage collection operation upon the first GCU to migrate currently valid data out of the first GCU followed by an erasure of all of the blocks in the first GCU, wherein the rearranging step comprises reformatting the first GCU by jettisoning at least one erased block from the first GCU and by adding at least one new erased block to the first GCU.

13. An apparatus comprising:
a memory comprising a plurality of data storage blocks each having an associated physical location in the memory, wherein a group of the blocks are arranged into a first garbage collection unit (GCU); and
a GCU generation engine adapted to measure parametric performance of the blocks in the first GCU and to migrate at least one block from the first GCU into a different, second GCU responsive to said measured parametric performance.

14. The apparatus of claim 13, in which the GCU generation engine forms the second GCU of blocks which have discontinuous physical locations and which share a common parametric performance measurement as obtained by the GCU generation engine.

15. The apparatus of claim 14, in which the second OCU is dedicated to storing user data from a host device having a relatively high priority level, and at least one other GCU formed by the GCU generation engine from blocks sharing a different common parametric performance measurement obtained by the GCU generation engine is dedicated to storing user data from a host device having a relatively low priority level.

16. The apparatus of claim 13, in which the GCU generation engine further migrates at least one other block from the memory to the first GCU so that the first GCU is formed of blocks sharing a common parametric performance measurement.

17. The apparatus of claim 13, in which the GCU generation engine forms the second GCU to increase the overall data storage capacity thereof by adding at least one additional block to the first GCU as the first GCU stores currently valid user data.

18. The apparatus of claim 13, in which the memory is characterized as a flash memory and the blocks are characterized as erasure blocks comprising a plurality of flash memory cells adapted for concurrent erasure.

19. An apparatus comprising:
a memory having a plurality of addressable erasure blocks arranged into a First plurality of garbage collection units (GCUs) ; and
a control circuit adapted to allocate the first plurality of GCUs for storage of user data, to measure parametric performance of each of the erasure blocks therein, and to reformat a selected GCU from the first plurality of GCUs to group together erasure blocks having a common parametric performance measurement into the selected GCU.

20. The apparatus of claim 19, in which the common parametric performance measurement comprises a common charge distribution range of accumulated charge in memory cells in the grouped together erasure blocks.
